(19) United States
(12) Patent Application Publication
(10) Pub. No.: US 2008/0316660 A1
(43) Pub. Date: Dec. 25, 2008

(54) ELECTROSTATIC DISCHARGE AVOIDING CIRCUIT

(75) Inventors: Shao-Chang Huang, Hsinchu City (TW); Ke-Hong Chen, Taipei County (TW); Hsin-Ming Chen, Tainan County (TW)

Correspondence Address: J C PATENTS, INC., 4 VENTURE, SUITE 250, IRVINE, CA, 92618, US

(73) Assignee: EMEMORY TECHNOLOGY INC., Hsin-Chu City (TW)

(21) Appl. No.: 11/765,857

(22) Filed: Jun. 20, 2007

(51) Int. Cl. H02H 9/04; H02H 9/00

(52) U.S. Cl. 361/56

(57) ABSTRACT

An electrostatic discharge (ESD) avoiding circuit comprises an ESD detecting unit and a switch unit. The ESD detecting unit is coupled to a first conductive path for detecting whether the ESD happened or not. The switch unit is coupled between the first conductive path and a core circuit for switching whether the first conductive path is conducted to the core circuit or not according to a detection result of the ESD detecting unit. The ESD avoiding circuit can avoid an electrostatic current transmitting to the core circuit when the ESD is happened, and the ESD avoiding circuit can make the normal signal/voltage providing to the core circuit for operating when the ESD isn't happened.

### BACKGROUND OF THE INVENTION

1. Field of the Invention

The present invention relates to an ESD avoiding circuit. More particularly, the present invention relates to a circuit which can avoid an ESD current transmitting into a core circuit when the ESD is happened.

2. Description of Related Art

Electronic products often suffer the effect of ESD and cause damages in practical use. Generally speaking, an ESD voltage is much higher than a common power supply voltage and the ESD current is likely to burn the elements when ESD occurs. Such that some ESD protection measures must be taken in the circuit to effectively isolate the ESD current.

A conventional ESD protection circuit is usually implemented by a gate-grounded n-channel metal-oxide-semiconductor (GGNMOS) transistor. FIG. 1 is a circuit diagram of a conventional ESD protection device. Referring to FIG. 1, the NMOS transistor N0 is a thick oxide NMOS transistor and a trigger-on voltage Vt of the NMOS transistor N0 is between 6V and 10V, such as Vt=8V.

In the normal operation mode, the core circuit 102 operates according to a schemed program voltage, wherein the program voltage can be a voltage with time variation, a swing voltage, and a fixed power voltage. Assume that the program voltage is a fixed power voltage herein, such as 7.5V.

In the ESD mode, a high voltage of ESD enters via a pad 101. At this time, on condition that the trigger-on voltage Vt of NMOS transistor N0 is larger than the program voltage. The ESD current may have passed to the core circuit 102 before the NMOS transistor N0 is conducted. In a word, the ESD current can't be bypassed to the ground voltage trace VSS through the NMOS transistor N0, but the ESD current enters the core circuit 102 to cause internal elements damaging instead.

People previously provided a surface trigger technique to lower a trigger-on voltage of NMOS transistor and the trigger-on voltage of such NMOS transistor is about 1V. FIG. 2A is a circuit diagram of a conventional ESD protection device. Referring to FIG. 2A, when a high voltage of ESD enters via a pad 201 in the ESD mode, a high level signal (the signal of the pad 201) is coupled to a gate of NMOS transistor N0 through PMOS transistor P1. The NMOS transistor N0 is conducted and then the ESD current is bypassed to the ground voltage trace VSS.

When a program voltage is supplied via the pad 201 in the normal operation mode, a RC circuit composed of the resistor R and the capacitance C would provide a high level signal to an input terminal of the inverter 203. The inverter 203 is composed of the PMOS transistor P1 and the NMOS transistor N1. The NMOS transistor N1 is conducted after the high signal is inverted, and then a gate voltage of the NOMS transistor N0 is pulled down to the ground voltage VSS to make the NMOS transistor N0 not to be conducted. Therefore, a leakage current produced by the incorrect conduct of the NMOS transistor N0 can be avoided.

However, a period of time is needed to provide a steady program voltage. In the period that the program voltage increases to be steady, such as the program voltage increases from 0V to 3.3 V, the PMOS transistor P1 within the inverter 203 is likely to be conducted and then the NMOS transistor N0 is conducted. Therefore, the leakage current is bypassed to the ground voltage trace VSS through NMOS transistor N0.

Besides, the pad 201 is not allowed electrically connecting to a swing voltage because the RC circuit makes the signal from the pad 201 delay, and the delay signal would cause the incorrect operation of the inverter 203. FIG. 2B shows a circuit diagram with another coupling mode according to the prior art in FIG. 2A. Referring to FIG. 2B, the pad 204 coupled to the RC circuit is electrically connected to a steady power voltage (such as 3.3V), and the pad 201 is an input pad or an output pad. When a high voltage of ESD enters via the pad 201 in the ESD mode, the pad 204 can be seen floating connect, and a high level signal (the signal of the pad 204) is coupled to a gate of the NMOS transistor N0 through PMOS transistor P1. Then, the NMOS transistor N0 is conducted to bypass the ESD current.

According to the coupling mode in FIG. 2B, although the pad 204 can be electrically connected to the swing voltage in the normal operation mode, the higher program voltage (compared to the said power voltage, and the assumed program voltage is 7.5V herein) from the pad 201 makes the PMOS transistor P1 within the inverter 203 to be conducted and then the NMOS transistor N0 is conducted to cause the leakage current, too. Therefore, a present target of how to solve the incorrect conduct problem of NMOS transistor N0 to avoid the leakage current extremely desires to be improved.

Further, FIG. 3 is a circuit diagram of a conventional ESD protection device. Referring to FIG. 3, when in the ESD mode, the NMOS transistor N0 (or PMOS transistor P0) is used to bypass the ESD current from the pad 301 to the ground voltage trace VSS (or the system voltage trace VDD). Generally speaking, a larger resistance of the resistor R is added between the pad 301 and the core circuit 302 to make the great part of the ESD current to be bypassed through the NMOS transistor N0 (or PMOS transistor P0). The PMOS transistor P2 and the NMOS transistor N2 compose an input buffer 303.

However, when in the normal operation mode, an offset voltage is produced by a current passing through the resistor R. The offset voltage may cause the operation of the core circuit delay, even cause the core circuit not to operate. Moreover, the higher program voltage from the pad 301 may be larger than the trigger-on voltage of the PMOS transistor P0. The PMOS transistor P0 is likely conducted and then the leakage current is produced. Therefore, the PMOS transistor P0 can not be used in such situation mentioned above.

### SUMMARY OF THE INVENTION

An ESD avoiding circuit is provided by the present invention. The ESD avoiding circuit avoids an ESD current transmitting into a core circuit for protecting elements within the core circuit from being damaged when detecting the ESD is happened. And the ESD avoiding circuit can make a normal signal/voltage providing to the core circuit for normally operating when detecting the ESD is not happened.

An ESD avoiding circuit comprising an ESD detecting unit and a switch unit is provided. The ESD detecting unit is coupled to a first conductive path for detecting whether the ESD is happened or not. The switch unit is coupled between the first conductive path and a core circuit for switching whether the first conductive path is conducted to the core circuit or not according to a detection result of the ESD detecting unit.

According to an embodiment of the ESD avoiding circuit, the ESD avoiding circuit further comprises a first ESD protection unit. The first ESD protection unit transmits the electrostatic current between the first conductive path and a second conductive path.

According to an embodiment of the ESD avoiding circuit, the ESD detecting unit comprises a second and a third transistor. A gate and a first drain/source of the second transistor are respectively coupled to a first voltage and the first conductive path. The switch unit is controlled by an output of second drain/source of the second transistor. A gate and a first drain/source of the third transistor are respectively coupled to the gate and the second drain/source of the second transistor, and a second drain/source and a bulk of the third transistor is coupled to a second voltage.

According to an embodiment of the ESD avoiding circuit, the switch unit comprises a first switch. A first and a second terminal of the first switch are respectively coupled to the first conductive path and the core circuit. The first switch determines whether the first conductive path is conducted to the core circuit according to the detection result of the ESD detecting unit.

According to an embodiment of the ESD avoiding circuit, the switch unit comprises a fourth transistor. A gate of the fourth transistor is controlled by the ESD detecting unit, and a first and a second of the fourth transistor are respectively coupled to the first conductive path and the core circuit.

The present invention controls the switch unit to conduct or not conduct the first conductive path to the core circuit according to the ESD detecting unit which detects whether the ESD is happened or not. When the ESD is happened, the present invention controls the switch unit disconnecting the first conductive path from the core circuit to avoid the electrostatic current transmitting to the core circuit. When the ESD isn't happened, the present invention controls the switch unit to conduct the first conductive path with the core circuit in order to provide the program voltage to the core circuit for normally operating.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional ESD protection device.

FIG. 2A is a circuit diagram of a conventional ESD protection device.

FIG. 2B shows a circuit diagram with another coupling mode according to the prior art in FIG. 2A.

FIG. 3 is a circuit diagram of a conventional ESD protection device.

FIG. 4A is a chart of an ESD avoiding circuit according to an embodiment of the present invention.

FIG. 4B shows a circuit diagram of an ESD avoiding circuit according to the embodiment in FIG. 4A.

FIG. 4C shows a circuit diagram of an ESD avoiding circuit according to the embodiment in FIG. 4A.

FIG. 5A is a chart of an ESD avoiding circuit according to an embodiment of the present invention.

FIG. 5B shows a circuit diagram of an ESD avoiding circuit according to the embodiment in FIG. 5A.

FIG. 5C shows a circuit diagram of an ESD avoiding circuit according to an embodiment of the present invention.

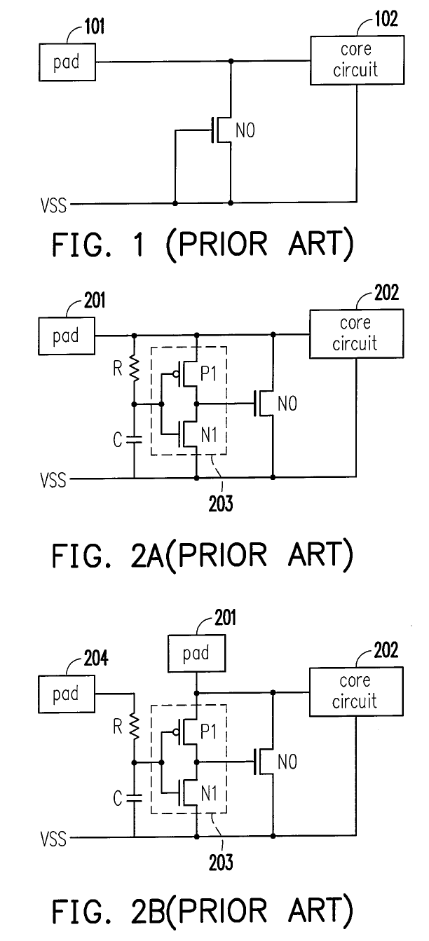

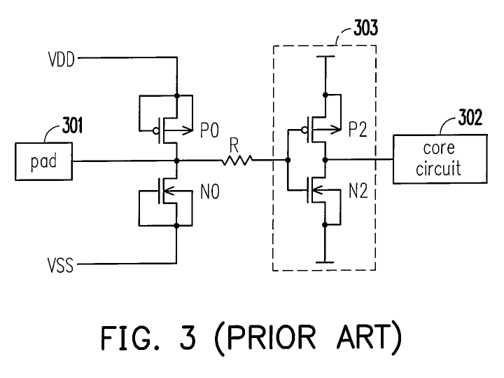

### DESCRIPTION OF EMBODIMENTS

In general, an ESD protection device is used for bypassing an ESD current in order to avoid the ESD current transmitting into the core circuit and the internal elements causing damages. In the ESD mode, the embodiment of the present invention utilizes an ESD avoiding circuit to disconnect the path which the ESD current can transmit to the core circuit. Besides, in the normal operation mode, the ESD avoiding circuit ensures that a normal signal/voltage can be transmitted between a pad and the core circuit.

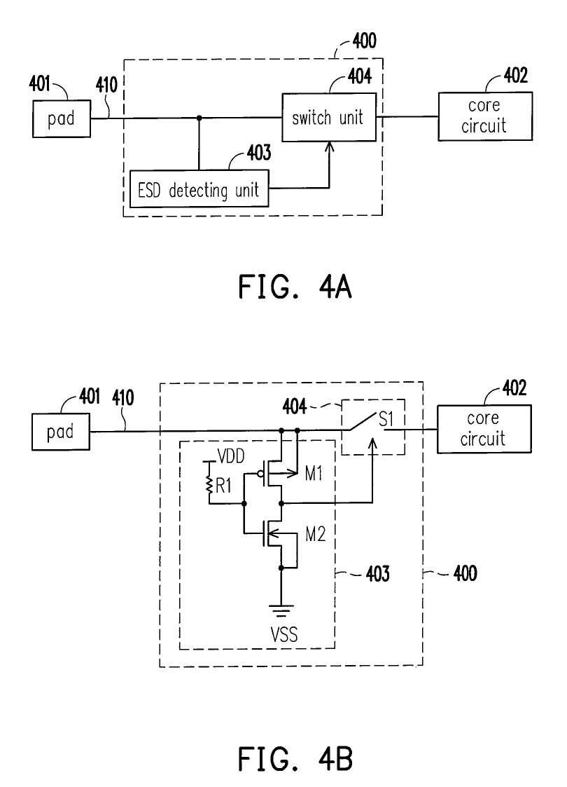

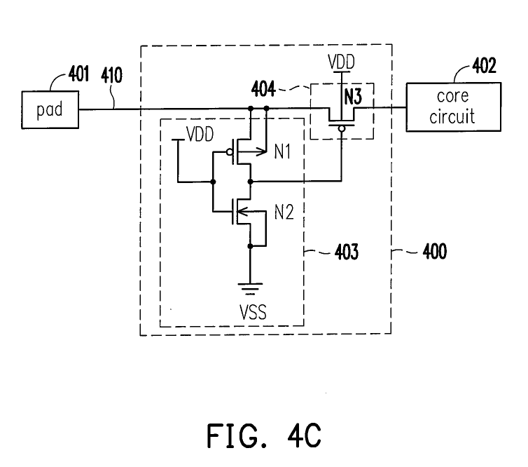

FIG. 4A is a chart of an ESD avoiding circuit according to an embodiment of the present invention. Referring to FIG. 4A, the ESD avoiding circuit 400 comprises an ESD detecting unit 403 and a switch unit 404. The ESD detecting unit 403 is coupled to a first conductive path 410 and used for detecting whether the ESD is happened or not. The first conductive path 410 can be coupled to an input pad 401 (or an output pad). The switch unit 404 is coupled between the first conductive path 410 and the core circuit 402 for switching whether the first conductive path is conducted to the core circuit 402 or not according to a detection result of the ESD detecting unit 403.

When the ESD detecting unit 403 detects the ESD is happened, the switch unit 404 is controlled by the ESD detecting unit 403 not to be conducted. Such that the ESD current can not pass to the core circuit 402 when a high voltage of the ESD enters via the pad 401 in the ESD mode. When the ESD detecting unit 403 detects the ESD is not happened, the switch unit 404 is controlled by the ESD detecting unit 403 to be conducted. Therefore, the normal signal/voltage is provided to the core circuit 402 through the switch unit 404 when the normal signal/voltage enters via the pad 401 in the normal operation mode.

Next, the operation of each unit is completely described as followed. FIG. 4B shows a circuit diagram of an ESD avoiding circuit according to the embodiment in FIG. 4A. Referring to FIG. 4B, the ESD detecting unit 403 comprises the transistors M1˜M2, wherein the transistor M1 is PMOS transistor and the transistor M2 is NMOS transistor. The switch unit 404 comprises a first switch S1.

A gate and a first drain/source of the transistor M1 are respectively coupled to a first voltage and the first conductive path 410, and an output of a second drain/source of the transistor M1 controls whether the first switch S1 is conducted or not. A gate, a first drain/source and a second drain/source of the transistor M2 are respectively coupled to a gate, a second drain/source of the transistor M1 and a second voltage. In the embodiment, a bulk of the transistor M1 is coupled to the first conductive path 410 and a bulk of the transistor M2 is coupled to the second voltage, wherein the first voltage is a system voltage VDD and the second voltage is a ground voltage VSS. A first and a second terminal of the first switch S1 are respectively coupled to the first conductive path 410 and the core circuit 402. Besides, a first resistor R1 is coupled between the gate of the second transistor M1 and the first voltage VDD for increasing gate-oxide reliability of the transistor M1˜M2.

When a high voltage of the ESD enters via the pad 401 in the ESD mode, the gate of the transistor M1, M2 can be seen floating connect. Hence, the transistor M1 is conducted and the transistor M2 is not conducted. At the same time, because the bulk of the transistor M1 is coupled to the first conductive path 410, a high level signal (the signal of the pad 401) is outputted from the second drain/source of the transistor M1 through the conducted transistor M1 and then controls the first switch S1 to switch off (not conduct).

When the normal signal/voltage enters via the pad 401 in the normal operation mode, the transistor M1 is not conducted and the transistor M2 is conducted due to the gates of them are coupled to the first voltage. Because the transistor M1 is not conducted, there is no leakage current passing through the transistor M1. A low level signal (the second voltage) is outputted from the second drain/source of the transistor M1 through the conducted transistor M2 and then controls the first switch S1 to switch on (conduct). Hence, the normal signal/voltage is provided to the core circuit 402. In another embodiment of the present invention, the bulk of the transistor M1 is coupled to the first voltage and the normal signal/voltage also can be provided to the core circuit 402 according to the above-mentioned operation.

FIG. 4C shows a circuit diagram of an ESD avoiding circuit according to the embodiment in FIG. 4A. Referring to FIG. 4B and FIG. 4C, the difference between FIG. 4B and FIG. 4C is that the switch unit 404 in FIG. 4C uses a transistor N3 to replace the first switch S1, wherein the transistor N3 is PMOS transistor. In the embodiment, a bulk of the transistor N3 is coupled to the first voltage (for example, the system voltage VDD).

The operation of the embodiment in FIG. 4C is the same as that in FIG. 4B. In the ESD mode, a high level signal (the signal of the pad 401) is outputted from the second drain/source of the transistor N1 to the gate of the transistor N3 through the conducted transistor N1. Hence, the transistor N3 is not conducted and the ESD current does not pass to the core circuit 402.

In the normal operation mode, the transistor N1 is not conducted and the transistor N2 is conducted due to the gates of them are coupled to the first voltage. Through the conducted transistor N2, a low level signal (the second voltage) is outputted from the second drain/source of the transistor N1 to the gate of the transistor N3. Therefore, the normal signal/voltage is provided to the core circuit 402 through the conducted transistor N3.

The foregoing description of the embodiment in FIG. 4A, FIG. 4B, and FIG. 4C shows that the ESD avoiding circuit 400 utilizes the switch unit 404 to avoid the ESD current passing to the core circuit 402 when the ESD is happened. When the ESD is not happened, no matter what the pad is electrically connected to a voltage with time variation, a swing voltage, or a fixed power voltage, the normal signal/voltage can be provided to the core circuit through the switch unit 404. In another embodiment of the present invention, the first conductive path 410 is coupled to a power pad for providing a power supply voltage to the core circuit 402.

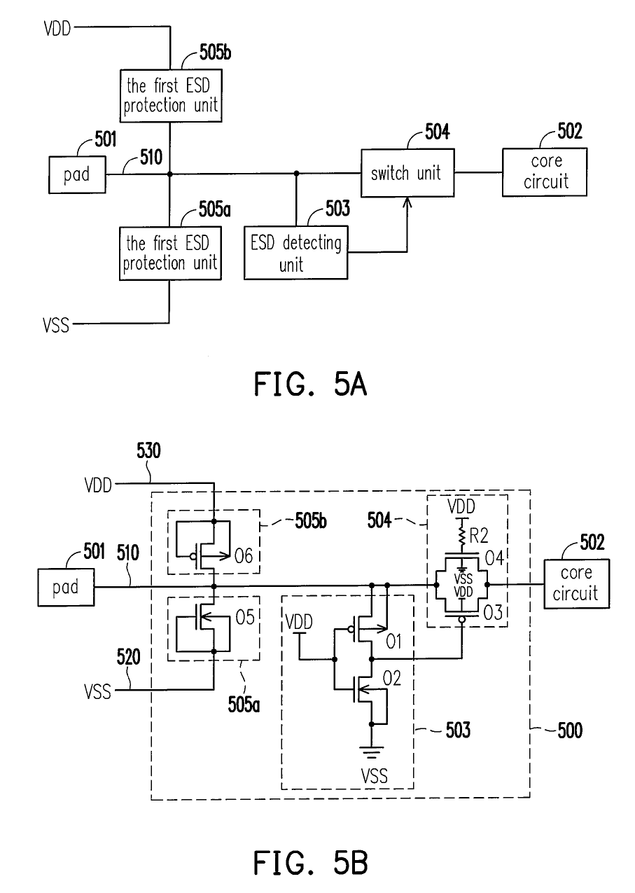

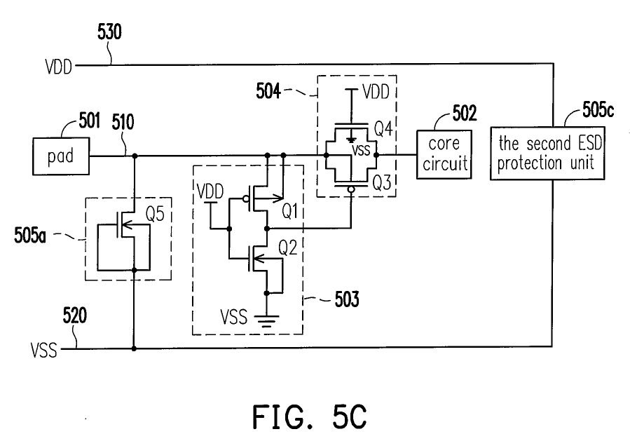

Besides, the above-mentioned ESD avoiding circuit 400 can add the first ESD protection units to be the paths bypassing the avoided ESD current. FIG. 5A is a chart of an ESD avoiding circuit according to an embodiment of the present invention. Referring to FIG. 4A and FIG. 5A, the difference between FIG. 4A and FIG. 5A is that the ESD avoiding circuit of the embodiment in FIG. 5A further comprises the first ESD protection units 505a, 505b.

In the ESD mode, the switch unit 504 is controlled by the ESD detecting unit 503 to not conduct the first conductive path 510 to the core circuit 502. At the same time, the first ESD protection units 505a, 505b can respectively bypass the ESD current to a second conductive path 520 and a third conductive path 530, wherein the second conductive path 520 could be coupled to the ground voltage VSS, and the third conductive path 530 could be coupled to the system voltage VDD.

FIG. 5B shows a circuit diagram of an ESD avoiding circuit according to the embodiment in FIG. 5A. Referring to FIG. 5B, the first ESD protection units 505a, 505b respectively comprise the first transistors O5, O6, wherein the first transistor O5 is NMOS transistor, and the first transistor O6 is PMOS transistor. A bulk of the first transistor O5 is coupled to the second conductive path 520, and a bulk of the first transistor O6 is coupled to the third conductive path 530. And that, the switch unit 504 comprises the transistors O3˜O4, wherein the transistor O3 is PMOS transistor, the transistor O4 is NMOS transistor. A bulk of the transistor O3 is coupled to the first voltage (for example, the system voltage VDD) and a bulk of the transistor O4 is coupled to the second voltage (for example, the ground voltage VSS). Besides, a second resistor R2 is coupled between the gate of the transistor O4 and the first voltage VDD for increasing gate oxide reliability of the transistor O4.

Commonly, there are several tests for the ESD, which can be classified into IO-VDD (+), IO-VSS (+), IO-VDD (−), and IO-VSS (−) modes. The IO-VDD (+)/IO-VDD (−) mode is that a high voltage of the ESD with a positive pulse/negative pulse is inputted via the pad 501 and the ESD current can be bypassed to the third conductive path 530. The IO-VSS (+)/IO-VSS (−) mode is that the high voltage of the ESD with a positive pulse/negative pulse is inputted via the pad 501 and the ESD current can be bypassed to the second conductive path 520. According to these modes, the embodiment of the present invention in FIG. 5B is described as follow.

When the high voltage of the ESD with a positive pulse enters via the pad 501 in the ESD mode, the gates of the transistors O1, O2, and O4 can be seen floating connect. Due to the bulk of the transistor O1 is coupled to the first conductive path 510, a high level signal (the signal of the pad 501) is outputted from the second drain/source of the transistor O1 to the gate of the transistor O3 through the conducted transistor O1 easily. Therefore the transistor O3 is not conducted and the ESD current does not pass to the core circuit 502. In the meantime, the ESD current is bypassed to the second conductive path 520 through the conducted first transistor O5. In addition, the ESD current could be also bypassed to the third conductive path 530 through a forward-bias diode within the first transistor O6.

When the high voltage of the ESD with a negative pulse enters via the pad 501, the ESD current is bypassed to the second conductive path 520 through a forward-bias diode within the first transistor O5. In another embodiment of the present invention, other ESD protection unit (not shown in FIG. 5B) can be added between the second conductive path 520 and the third conductive path 530 in order to bypass the ESD current from the second conductive path 520 to the third conductive path 530 through itself.

When the normal signal/voltage enters via the pad 501 in the normal operation mode, due to the gate of the transistor O1 is coupled to the first voltage, the transistor O1 is not conducted to avoid producing the leakage current. And due to the gates of the transistors O2, O4 are coupled to the first voltage, the transistors O2, O4 are conducted. Through the conducted transistor O2, a low level signal (the second voltage) is outputted from the second drain/source of the transistor O1 to the gate of the transistor O3 for conducting the transistor O3. Consequently, the normal signal/voltage is provided to the core circuit 502 through the conducted transistor O3 or the conducted transistor O4.

The foregoing description of the embodiments in FIG. 5A and FIG. 5B shows that the ESD avoiding circuit not only avoids the ESD current passing to the core circuit 502 in the ESD mode, but also bypasses the ESD current. Moreover, the normal signal/voltage is provided to the core circuit 502 through the transmission gate composed of the transistor O3 and the transistor O4.

FIG. 5C shows a circuit diagram of an ESD avoiding circuit according to an embodiment of the present invention. Referring to FIG. 5B and FIG. 5C, the difference between FIG. 5B and FIG. 5C is that the bulk of the transistor Q3 within the switch unit 504 of the embodiment in FIG. 5C is coupled to the first conductive path 510. Referring to FIG. 5B, when the higher voltage (compared to the system voltage VDD) enters via the pad 501 in the normal operation mode, the transistor O6 may be incorrectly conducted and then produce the leakage current. For this reason, the embodiment in FIG. 5C removes the first ESD protection unit 505b of the embodiment in FIG. 5B, and further adds a second ESD protection unit 505c, wherein the second ESD protection unit 505c is coupled between the second conductive path 520 and the third conductive path 530 and used for transmitting the ESD current between the second conductive path 520 and the third conductive path 530.

As the same with the operation of the embodiment in FIG. 5B, when detecting the ESD is happened, the ESD detecting unit 503 simultaneously controls the switch unit 504 disconnecting the path which the ESD current can pass to the core circuit 502. And the ESD current can be bypassed to the second conductive path 520 through the first ESD protection unit 505a, or bypassed from the second conductive path 520 to the third conductive path 530 through the second ESD protection unit 505c.

When the higher voltage (compared to the system voltage VDD) enters via the pad 501 in the normal operation mode, due to the bulk of the transistor Q3 is coupled to the first conductive path 510 and the conducted transistor Q2 sends the low level signal (the second voltage) to the gate of the transistor Q3, the higher voltage is provided to the core circuit 502 through the conducted transistor Q3.

It is noted that the first ESD protection units 505a, 505b, and the second ESD protection unit 505c of the foregoing embodiments in FIG. 5B, and FIG. 5C are implemented by the transistors, but the present invention is not limited in that. Any person ordinarily skilled in the art could utilize other elements, such as diodes, to substitute for the transistors. For example, the first ESD protection unit 505a is implemented by a diode. A cathode and an anode of the diode are respectively coupled to the first conductive path 510 and the second conductive path 520. For example, the first ESD protection unit 505b is implemented by a diode. An anode and a cathode of the diode are respectively coupled to the first conductive path 510 and the third conductive path 530. For example, the second ESD protection unit 505c is implemented by a second diode. An anode and a cathode of the second diode are respectively coupled to the second conductive path 520 and the third conductive path 530.

In summary, when the ESD detecting unit detects the ESD is happened, the embodiments in FIG. 4A, FIG. 4B, and FIG. 4C utilizes the switch unit to disconnect the path which the ESD can pass to the core circuit. In the normal operation mode, the normal signal/voltage is provided to the core circuit through the switch unit. Besides, the embodiments in FIG. 5A and FIG. 5B further add the ESD protection units to bypass the ESD current. The embodiment in FIG. 5C which considers that a high program voltage is provided to the core circuit in the normal operation mode ensures the higher program voltage being provided to the core circuit through the switch unit, and avoids the ESD protection units (such as the first ESD protection unit 505b in FIG. 5B) being incorrectly conducted to produce the leakage current.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. An electrostatic discharge (ESD) avoiding circuit, comprising:
an ESD detecting unit, coupled to a first conductive path, for detecting whether the ESD happened or not;
a switch unit, coupled between the first conductive path and a core circuit, for switching whether the first conductive path is conducted to the core circuit or not according to a detection result of the ESD detecting unit.

2. The ESD avoiding circuit as claimed in claim 1, further comprising:
a first ESD protection unit for transmitting an electrostatic current between the first conductive path and a second conductive path.

3. The ESD avoiding circuit as claimed in claim 2, wherein the first ESD protection unit comprises:
a first transistor, having a first drain/source coupled to the first conductive path, and a gate, a second drain/source, and a bulk coupled to the second conductive path.

4. The ESD avoiding circuit as claimed in claim 2, wherein the first ESD protection unit comprises:
a first diode, having an anode coupled to the first conductive path, and a cathode coupled to the second conductive path.

5. The ESD avoiding circuit as claimed in claim 2, wherein the first ESD protection unit comprises:
a first diode, having a cathode coupled to the first conductive path, and an anode coupled to the second conductive path.

6. The ESD avoiding circuit as claimed in claim 2, wherein the second conductive path is coupled to a system voltage which is the IC system operation voltage.

7. The ESD avoiding circuit as claimed in claim 2, wherein the second conductive path is coupled to a ground voltage.

8. The ESD avoiding circuit as claimed in claim 2, further comprising:
a second ESD protection unit, for transmitting the electrostatic current between the second conductive path and a third conductive path.

9. The ESD avoiding circuit as claimed in claim 8, wherein the second ESD protection unit comprises:
a second diode, having an anode coupled to the second conductive path, and a cathode coupled to the third conductive path.

10. The ESD avoiding circuit as claimed in claim 8, wherein the second conductive path is coupled to a ground voltage.

11. The ESD avoiding circuit as claimed in claim 8, wherein the third conductive path is coupled to a system voltage.

12. The ESD avoiding circuit as claimed in claim 1, wherein the ESD detecting unit comprises:
a second transistor, having a first drain/source coupled to the first conductive path, a gate coupled to a first voltage, wherein the switch unit is controlled by an output of a second drain/source; and
a third transistor, having a first drain/source coupled to the second drain/source of the second transistor, a gate coupled to the gate of the second transistor, a second drain/source and a bulk coupled to a second voltage.

13. The ESD avoiding circuit as claimed in claim 12, wherein the ESD detecting unit further comprises:
a first resistor, coupled between the gate of the second transistor and the first voltage source.

14. The ESD avoiding circuit as claimed in claim 12, wherein a bulk of the second transistor is coupled to the first voltage source.

15. The ESD avoiding circuit as claimed in claim 12, wherein a bulk of the second transistor is coupled to the first conductive path.

16. The ESD avoiding circuit as claimed in claim 12, wherein the first voltage is a system voltage and the second voltage is a ground voltage.

17. The ESD avoiding circuit as claimed in claim 1, wherein the switch unit comprises:
a first switch, having a first terminal coupled to the first conductive path, and a second terminal coupled to the core circuit for determining whether the first conductive path is conducted to the core circuit according to the detection result of the ESD detecting unit.

18. The ESD avoiding circuit as claimed in claim 1, wherein the switch unit comprises:
A fourth transistor, having a first drain/source coupled to the first conductive path, a gate controlled by the ESD detecting unit, and a second drain/source coupled to the core circuit.

19. The ESD avoiding circuit as claimed in claim 18, wherein a bulk of the fourth transistor is coupled to a first voltage source.

20. The ESD avoiding circuit as claimed in claim 18, wherein a bulk of the fourth transistor is coupled to the first conductive path.

21. The ESD avoiding circuit as claimed in claim 18, wherein the switch unit further comprises:
a fifth transistor, having a first drain/source coupled to the first drain/source of the fourth transistor, a gate coupled to a first voltage, and a second drain/source coupled to the second drain/source of the fourth transistor.

22. The ESD avoiding circuit as claimed in claim 21, wherein the switch unit further comprises:
a second resistor, coupled between the gate of the fifth transistor and the first voltage source.

23. The ESD avoiding circuit as claimed in claim 21, wherein a bulk of the fifth transistor is coupled a second voltage source.

24. The ESD avoiding circuit as claimed in claim 1, wherein the first conductive path is coupled to an input pad which is the IC signal input port.

25. The ESD avoiding circuit as claimed in claim 1, wherein the first conductive path is coupled to an output pad which is the IC signal output port.

26. The ESD avoiding circuit as claimed in claim 1, wherein the first conductive path is coupled to a power pad which applies the power to the IC.
